(19) United States
(12) Patent Application Publication
(10) Pub. No.: US 2011/0240385 A1
(43) Pub. Date: Oct. 6, 2011

(54) Hybrid module for a vehicle

(76) Inventor: Daniel J. Farmer, Battle Ground, WA (US)

(21) Appl. No.: 12/662,182

(22) Filed: Apr. 5, 2010

(51) Int. Cl. B60W 20/00; B60K 1/00

(52) U.S. Cl. 180/65.27; 180/65.1

(57) ABSTRACT

An apparatus for a hybrid vehicle is disclosed. The apparatus has a detachable module including an energy storage device and a module drive device connected to the energy storage device, the module drive device configured to convert between electrical energy and mechanical energy. The apparatus also has an energy recovery device electrically connected to the energy storage device. The apparatus additionally has a mechanical connector selectively connecting the module drive device to a vehicle powertrain, wherein the module drive device drives the powertrain via the mechanical connector.

### TECHNICAL FIELD

The present disclosure relates to a detachable hybrid module for a vehicle.

### BACKGROUND

Military vehicles serve in both high performance roles and low performance roles, depending on the mission to be accomplished. Military vehicles serve as high performance vehicles in missions such as, for example, combat missions where high speeds, power output, and acceleration are useful. In the high performance mode, it is useful for military vehicles to be light-weight to improve performance, and to have an ability to travel long distances and/or operate for an extended duration. Typically, liquid fuel used in conjunction with combustion engines is the most practical energy source for the high performance mode.

Military vehicles serve as low performance vehicles in missions such as, for example, patrol and supply missions, where attributes such as stealth and fuel economy are useful. For example, military vehicles in the low performance mode use electrical power to execute “silent watch” and “silent move” areas such as in civilian areas where it is helpful to reduce vehicle noise levels. When operating as a low performance vehicle, weight is less of a concern, and electrical generation, fuel savings and quiet operation are more useful. Also, the low performance mode is useful to reduce strain on military supply lines servicing combat line units. Hybrid vehicles may have these characteristics and are thus practical for operating in the low performance mode.

Because military vehicles often switch between the high performance mode and the low performance mode based on rapidly changing mission requirements and orders, it is important to have vehicles that can be quickly adapted between the two modes. However, a problem in operating military vehicles is the difficulty to rapidly switch between the high performance mode and the low performance mode. A detachable hybrid module is described that addresses this problem by making a vehicle quickly adaptable between the high performance mode and the low performance mode.

### SUMMARY OF THE DISCLOSURE

In accordance with one aspect, the present disclosure is directed toward an apparatus for a hybrid vehicle. The apparatus includes a detachable module including an energy storage device and a module drive device connected to the energy storage device, the module drive device configured to convert between electrical energy and mechanical energy. The apparatus also includes an energy recovery device electrically connected to the energy storage device. The apparatus further includes a mechanical connector selectively connecting the module drive device to a vehicle powertrain, wherein the module drive device drives the powertrain via the mechanical connector.

### BRIEF DESCRIPTION OF THE DRAWINGS

FIG. 1 is an illustration of an exemplary vehicle having a hybrid module;

FIG. 2 is a schematic illustration of a first configuration of the exemplary vehicle of FIG. 1 having a hybrid module;

FIG. 3 is a schematic illustration of a second configuration of the exemplary vehicle of FIG. 1 having a hybrid module;

FIG. 4 is a schematic illustration of a third configuration of the exemplary vehicle of FIG. 1 having a hybrid module;

FIG. 5 is a schematic illustration of a fourth configuration of the exemplary vehicle of FIG. 1 having a hybrid module;

FIG. 6 is an illustration of another exemplary vehicle having a hybrid module; and

FIG. 7 is a flow chart of an exemplary method for converting a vehicle into a hybrid vehicle.

### DETAILED DESCRIPTION

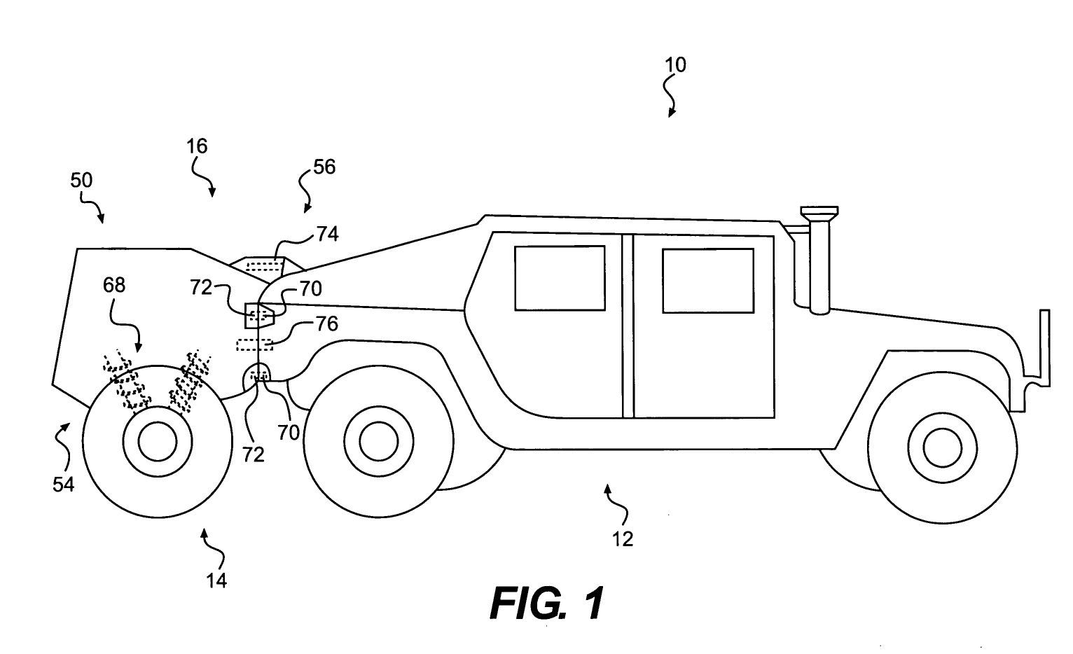

FIG. 1 illustrates a vehicle 10 that may be a high performance vehicle such as, for example, a military vehicle. It is also contemplated that vehicle 10 may be any other high performance vehicle such as, for example, a construction vehicle or a commercial vehicle. Vehicle 10 may include a powertrain 12, an additional axle 14 that may be disposed outside of powertrain 12, and a hybrid assembly 16 that may selectively recover energy from, or selectively drive, powertrain 12 and/or additional axle 14.

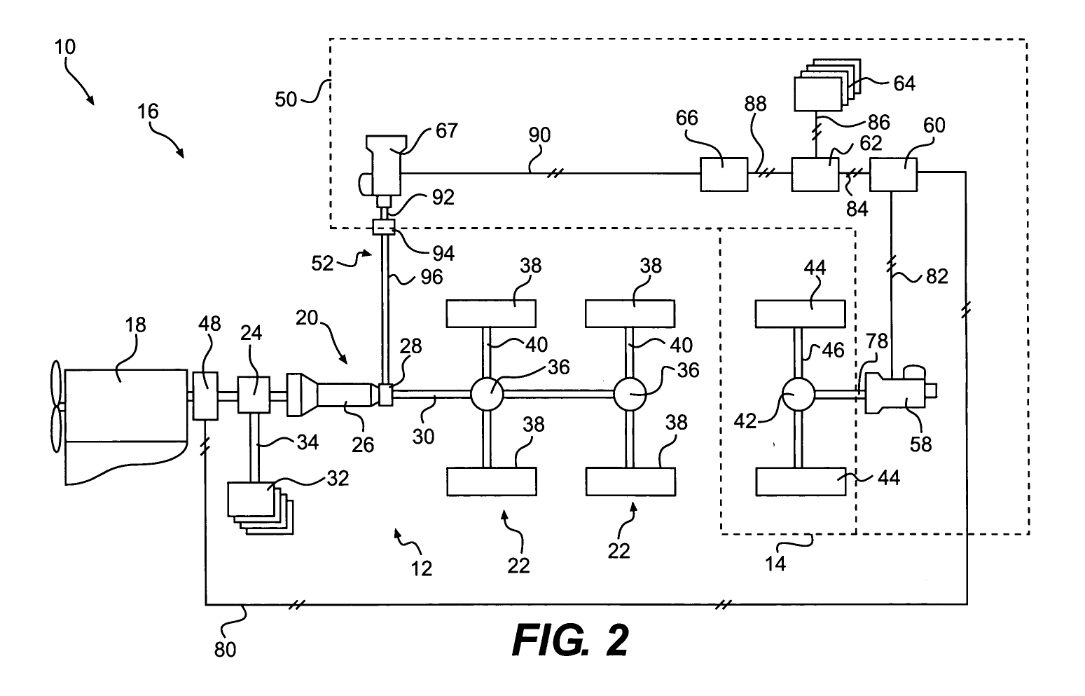

As shown in FIGS. 2-5, powertrain 12 may include a power source 18, a drivetrain 20, and one or more vehicle axles 22. Power source 18 may drive drivetrain 20 and vehicle axles 22.

Power source 18 may be an engine such as, for example, a diesel engine, a gasoline engine, a gaseous fuel-powered engine, or any other type of combustion engine known in the art. It is also contemplated that power source 18 may alternatively embody a non-combustion source of power such as a fuel cell, an accumulator, or another source known in the art.

Drivetrain 20 may include an accessory drive 24, a transmission 26, a transfer case 28, and a driveshaft 30. Accessory drive 24, transmission 26, transfer case 28, and one or more driveshafts 30 may transfer power from power source 18 to the various components of vehicle 10 such as vehicle axles 22.

Accessory drive 24 may transfer power from power source 18 to one or more components 32 of vehicle 10 via one or more mechanical connectors 34. Components 32 may include vehicle accessories such as, for example, a water pump, cooling components, a supercharger, and electrical system components.

Transmission 26 may be any suitable transmission known in the art such as, for example, a multi-speed bi-directional mechanical transmission having a neutral gear ratio, a plurality of forward gear ratios, a plurality of reverse gear ratios, and one or more clutches. Transmission 26 may be an automatic-type transmission, shifting based on a power source speed, a maximum selected gear ratio, and a shift map, or a manual-type transmission, shifting between each gear as initiated by an operator.

Transfer case 28 may be any suitable arrangement of transfer gears for transferring power from transmission 26 to vehicle axles 22. Transfer case 28 may be connected to transmission 26 and may transfer power to all vehicle axles 22 via one or more driveshafts 30, thereby facilitating all-wheel drive of vehicle axles 22.

Each vehicle axle 22 may include an output 36, traction devices 38, and a mechanical connector 40. Driveshaft 30 may be operably connected to vehicle axles 22 via outputs 36. Traction devices 38 may thereby be driven by power transferred from drivetrain 20 via mechanical connectors 40. Traction devices 38 may be any suitable devices known in the art such as, for example, tires or tracks.

Additional axle 14 may be similar to vehicle axles 22, but may be unconnected to powertrain 12 and disposed outside of powertrain 12. Additional axle 14 may include an output 42, traction devices 44, and a mechanical connector 46. Traction devices 44 may be operably connected to output 42 via mechanical connector 46.

Hybrid assembly 16 may include an energy recovery device 48, a detachable module 50, and one or more mechanical connectors 52. Detachable module 50 may be selectively electrically connected to energy recovery device 48, and may be selectively mechanically attached to powertrain 12 and additional axle 14 via mechanical connector 52.

Energy recovery device 48 may be any suitable device for recovering energy from power source 18. For example, energy recovery device 48 may be a generator that is associated with powertrain 12 such as, for example, a flywheel generator that is attached to power source 18. Energy recovery device 48 may recover kinetic energy that is generated by power source 18 during power generation.

As depicted in FIGS. 1 and 2, detachable module 50 may include a support system 54, a coupling system 56, an energy recovery device 58, an inverter/converter 60, an energy storage device 62, an operations system 64, an inverter/converter 66, and a drive device 67, where these elements may be integrated together into detachable module 50. Detachable module 50 may operate independently of vehicle 10. For example, detachable module 50 may operate independently to provide energy for other applications such as, for example, providing power for an operations center. Support system 54 may support detachable module 50, coupling system 56 may help to detach and attach detachable module 50 to vehicle 10, and energy recovery device 58 may recover energy from vehicle 10. Operations system 64 may provide for the operation of detachable module 50, and energy inverters/converters 60 and 66 and energy storage device 62 may transfer and store the energy recovered by energy recovery device 58.

A “plug-in” configuration may be provided for attaching detachable module 50 to vehicle 10. Referring back to FIG. 1, support system 54 may include a suspension 68. Also, additional axle 14 may be integrated into support system 54, thereby integrating additional axle 14 into detachable module 50, as shown in FIG. 1. Suspension 68 may be any suitable device for supporting detachable module 50 on additional axle 14, and may include elements such as, for example, struts and shock absorbers to stabilize detachable module 50 during a movement of vehicle 10.

Coupling system 56 may provide for a rigid connection of detachable module 50 to vehicle 10. Coupling system 56 may include a vehicle coupling component 70, a module coupling component 72, a jacking system 74, and a connection assembly 76. Coupling components 70 and 72 may couple together to provide a rigid connection, and jacking system 74 may help to detach and attach detachable module 50 to vehicle 10. Connection assembly 76 may connect systems of detachable module 50 with systems of vehicle 10. Detachable module 50 may thereby be rigidly connected to vehicle 10.

One or more vehicle coupling components 70 may be mounted on vehicle 10, and one or more module coupling components 72 may be mounted on detachable module 50. Each vehicle coupling component 70 may be configured to be coupled with a respective module coupling component 72, so that when respective vehicle coupling components 70 are coupled with respective module coupling components 72, detachable module 50 is rigidly attached to vehicle 10. Coupling components 70 and 72 may be any suitable coupling components known in the art for providing attachment and detachment such as, for example, sleeve or clamp couplings. It is also contemplated that flexible couplings may be used.

Jacking system 74 may include any suitable jacking device known in the art for attaching and detaching detachable module 50 from vehicle 10 such as, for example, a hydraulic ram or a ratchet-type jack. Jacking system 74 may also include any suitable type of pneumatic, electrical, or manual jacking device. Jacking system 74 may operate to assist in quickly coupling and uncoupling coupling components 70 and 72, thereby helping to provide attachment and detachment of detachable module 50 from vehicle 10.

Connection assembly 76 may be any suitable assembly for connecting systems of detachable module 50 with systems of vehicle 10. Connection assembly 76 may include, for example, conduits for connecting electrical wiring, hydraulic and pneumatic passages, circuitry, and other transfer elements connecting detachable module 50 to vehicle 10.

Energy recovery device 58 may be any suitable device for selectively recovering energy from additional axle 14 such as, for example, a motor-generator that recovers kinetic energy from additional axle 14 and generates AC (alternating current) electrical power. As shown in FIG. 2, energy recovery device 58 may be associated with additional axle 14 and may be operably connected to output 42 of additional axle 14 via a mechanical connector 78. In addition to operating as a generator to recover energy from additional axle 14, energy recovery device 58 may also operate as a motor to selectively drive additional axle 14 via mechanical connector 78. Energy recovery device 58 may thereby both recover energy from and delivery energy to additional axle 14.

Inverter/converter 60 may be any suitable energy conversion device known in the art for converting AC electrical energy into DC (direct current) electrical energy. Inverter/converter 60 may be electrically connected to energy recovery device 48 via an electrical line 80, and may be electrically connected to energy recovery device 58 via an electrical line 82. Inverter/converter 60 may convert energy recovered by energy recovery devices 48 and 58.

Energy storage device 62 may be any suitable device for storing electrical energy such as, for example, a battery, a battery pack, or a capacitor. Energy storage device 62 may store DC electrical energy, and may be electrically connected to inverter/converter 60 via an electrical line 84.

Operations system 64 may include systems for operating detachable module 50 such as, for example, an electrical system, a hydraulic system, a pneumatic system, and a cooling system. Operations system 64 may also include a controller and circuitry for automated operation of detachable module 50. The various systems of operations system 64 may be integrated together within detachable module 50. Operations system 64 may be compatible with the operations systems of vehicle 10, and may be connected to the operations systems of vehicle 10 via connection assembly 76. For example, the controller of operations system 64 may be electrically connected to a vehicle electrical system, and the cooling system of operations system 64 may be fluidly connected and compatible with a vehicle cooling system. Operations system 64 may be electrically connected to energy storage device 62 via an electrical line 86 and thereby be powered by energy stored in energy storage device 62.

Energy storage device 62 may be electrically connected to inverter/converter 66 via an electrical line 88, where inverter/converter 66 may be similar to inverter/converter 60. Inverter/converter 66 may be electrically connected to drive device 67 via an electrical line 90. Drive device 67 may be any suitable device for converting between electrical energy and mechanical energy such as, for example, a motor and/or a pump. It is also contemplated that drive device 67 may be a motor-generator, capable of both using electrical energy to produce mechanical power and using mechanical energy to produce electrical power.

Mechanical connector 52 may be any suitable device for transferring mechanical power such as, for example, a driveshaft assembly. Mechanical connector 52 may be driven by drive device 67. Mechanical connector 52 may include a module element 92, a connector 94, and a vehicle element 96. Module element 92 and vehicle element 96 may be conventional mechanical elements such as, for example, rods and/or shafts, and may be mechanically connected to each other via connector 94, which may be any suitable conventional mechanical connector. Module element 92 may be integrated into detachable module 50 and may be operably connected to drive device 67. Vehicle element 96 may be disposed on vehicle 10, and connector 94 may be disposed on either detachable module 50 or vehicle 10. Module element 92 may thereby be attached to vehicle element 96 via connector 94 when detachable module 50 is attached to vehicle 10, and may be detached from vehicle element 96 when detachable module 50 is detached from vehicle 10. It is also contemplated that mechanical connector 52 may be a hydraulic or pneumatic assembly such as, for example, an assembly including one or more hydraulic or pneumatic hoses that are operably connected to drive device 67.

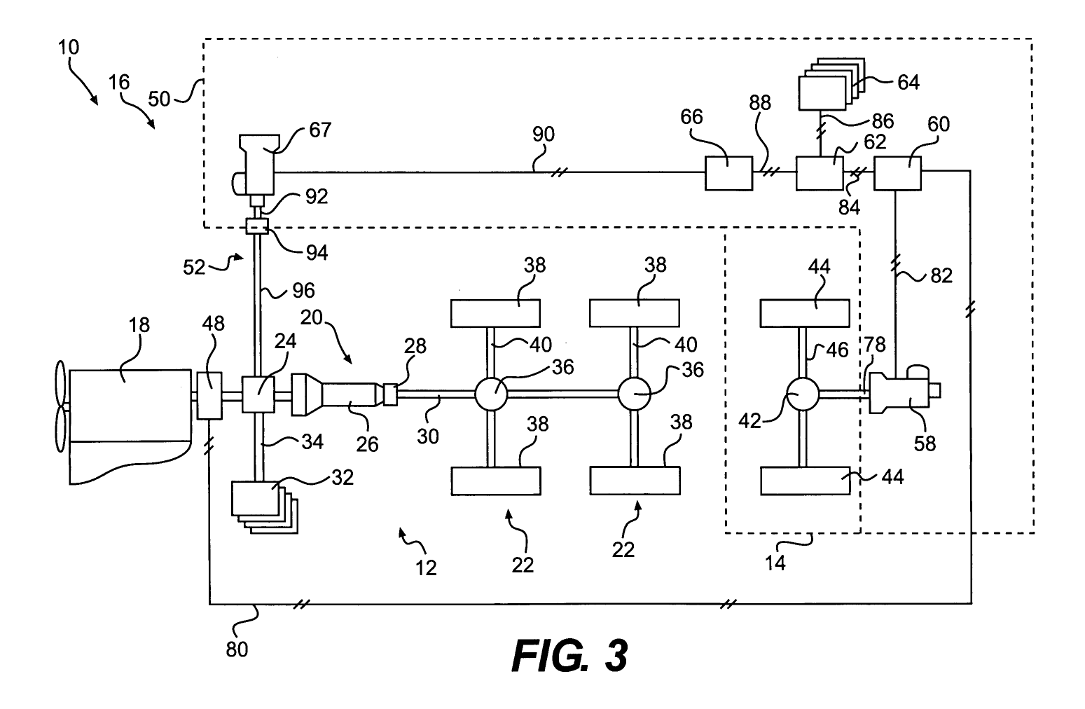

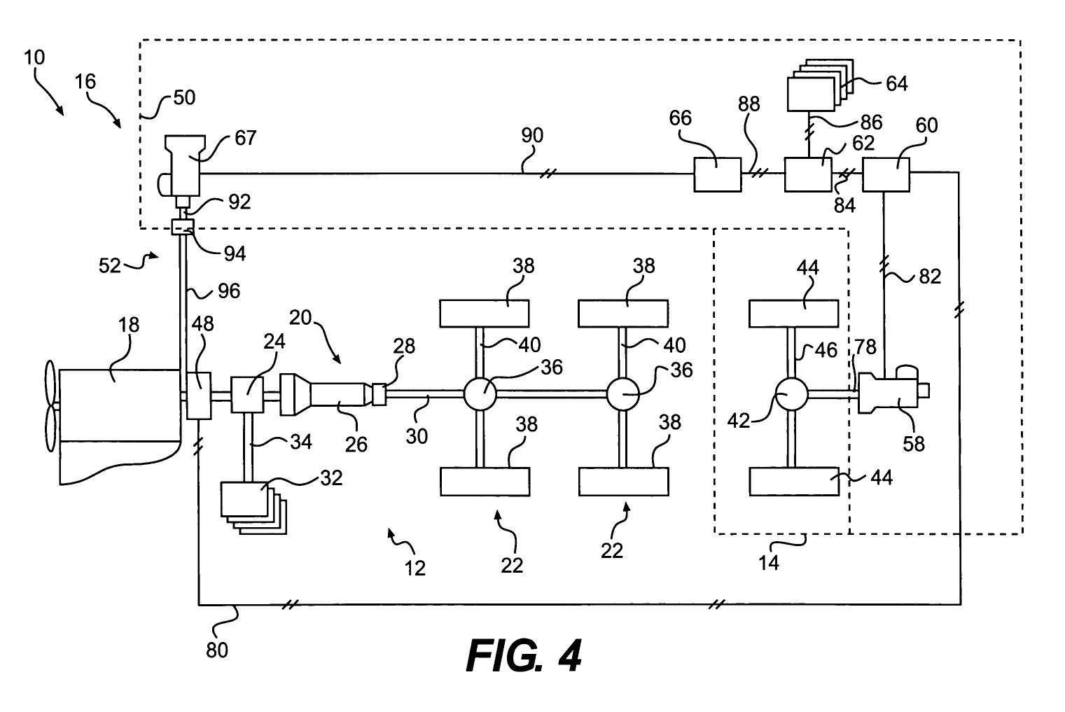

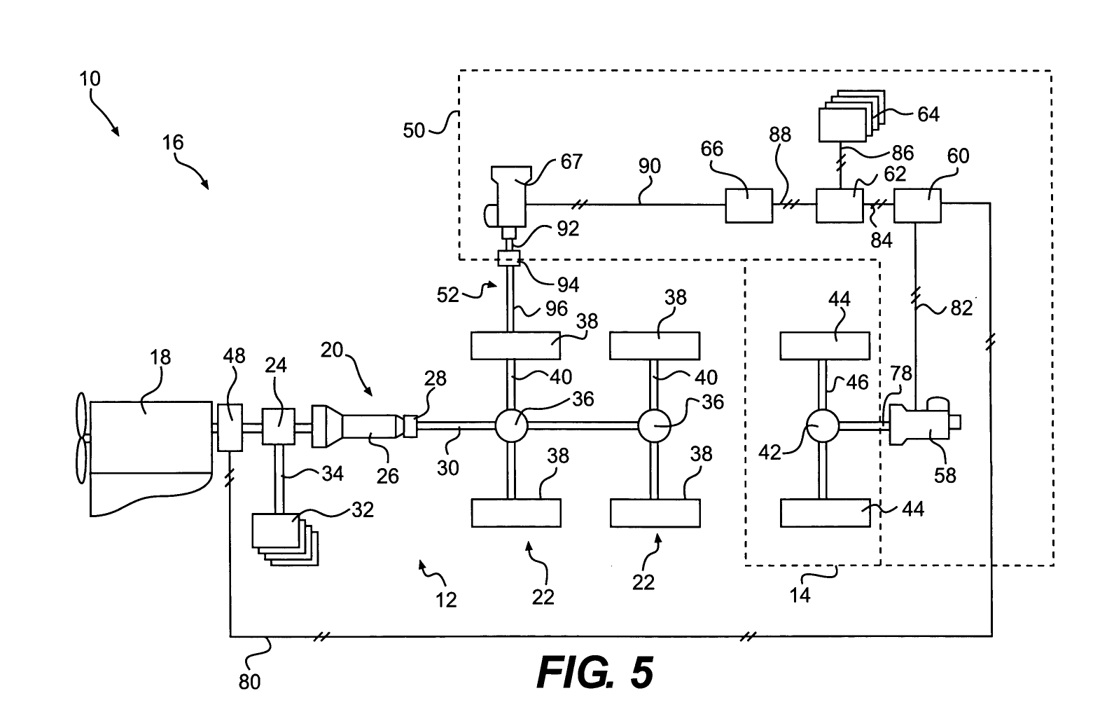

Vehicle element 96 of mechanical connector 52 may be operably connected to any suitable portion of powertrain 12. For example, as shown in FIG. 2, vehicle element 96 of mechanical connector 52 may be operably connected to transfer case 28. It is also contemplated that vehicle element 96 of mechanical connector 52 may be operably connected directly to transmission 26. As shown in FIG. 3, vehicle element 96 of mechanical connector 52 may be operably connected to accessory drive 24. As shown in FIG. 4, vehicle element 96 of mechanical connector 52 may be operably connected to power source 18. It is also contemplated that vehicle element 96 of mechanical connector 52 may be operably connected directly to driveshaft 30 (not depicted). As shown in FIG. 5, vehicle element 96 of mechanical connector 52 may be operably connected to one or more vehicle axles 22. One or more mechanical connectors 52 may selectively operably connect detachable module 50 to one or any combination of portions of powertrain 12, such as power source 18, vehicle axle 22, accessory drive 24, transmission 26, transfer case 28, and/or driveshaft 30, thereby providing a “tie-back” of drive from detachable module 50 to powertrain 12. It is also contemplated that powertrain 12 may selectively transfer mechanical power to detachable module 50 via mechanical connector 52.

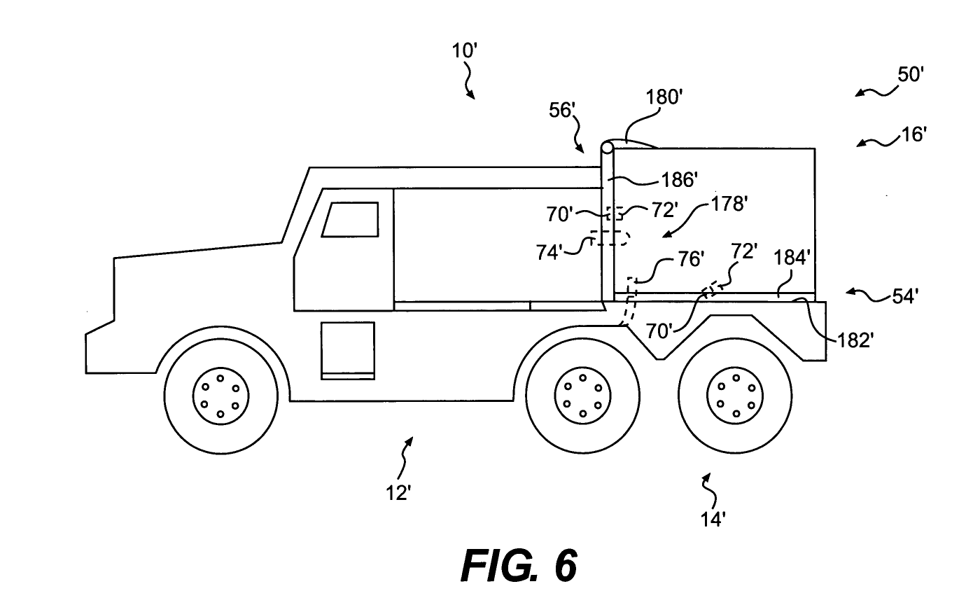

FIG. 6 depicts another exemplary embodiment of the disclosed hybrid assembly. Vehicle 10′ may include a powertrain 12′, an additional axle 14′, and a hybrid assembly 16′ having a detachable module 50′ that are similar to those described above for vehicle 10. It is contemplated that additional axle 14′ may not be integrated into detachable module 50′, with additional axle 14′ and detachable module 50′ instead being separate units, as shown in FIG. 6.

Detachable module 50′ may include a support system 54′ and a coupling system 56′. Coupling system 56′ may include one or more vehicle coupling components 70′, one or more module coupling components 72′, a jacking system 74′, and a connection assembly 76′ that are similar to those described above for detachable module 50.

Support system 54′ may include a support frame 178′ and a tie-down 180′. Support frame 178′ may be disposed on a bed 182′ of vehicle 10′. Support frame 178′ may include a suitable arrangement of structural members for supporting detachable module 50′ on bed 182′ such as, for example, members 184′ and 186′. Members 184′ and 186′ may be assembled by any suitable method known in the art such as, for example, via bolting or welding. Detachable module 50′ may thereby be received on support frame 178′ in a “drop-in” configuration.

Detachable module 50′ may be rigidly attached to support frame 178′ on bed 182′ via coupling components 70′ and 72′, and also by tie-down 180′. Tie-down 180′ may be any suitable device for exerting a force to help rigidly attach detachable module 50′ to vehicle 10′ such as, for example, a hydraulic, pneumatic, electric, or manual assembly that may apply a clamping force to rigidly fasten detachable module 50′ to vehicle 10′. The remaining components of vehicle 10′ may be similar to those described above and below for vehicle 10.

It is contemplated that an existing vehicle may be retrofitted with a retrofit kit including hybrid assembly 16 and 16′ to gain the benefits described herein. For example, the existing vehicle may be modified to include energy recovery device 48, vehicle element 96, and connector 94. The existing vehicle may also be modified to include support systems 54 and 54′ and coupling systems 56 and 56′. Detachable module 50 and 50′ may thereby be attached to a modified existing vehicle.

Hybrid assembly 16 may be used on any vehicle that may benefit from quickly adapting between a high performance mode and a low performance mode. More specifically, hybrid assembly 16 may be used on vehicles that operate both in a high performance mode using high speeds, acceleration, and power, and a low performance mode involving hybrid power that conserves fuel and allows vehicles to operate relatively quietly.

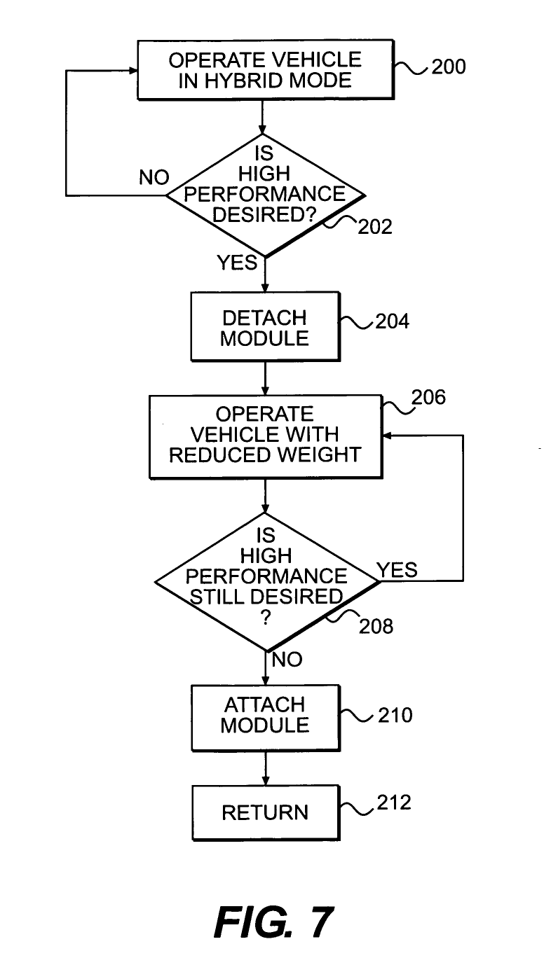

FIG. 7 illustrates a method for adapting hybrid vehicles 10 and/or 10′ into high performance vehicles and vice versa. Some or all of the steps of this method may be carried out automatically by the controller of operations system 64 and/or manually. In step 200, vehicle 10 operates in a low performance or hybrid mode, where detachable module 50 is attached to vehicle 10. Powertrain 12 generates power, and energy may be recovered via energy recovery device 48 and transferred to inverter/converter 60 via electrical line 80. As vehicle 10 moves, energy is recovered from additional axle 14 via energy recovery device 58 and transferred to inverter/converter 60 via electrical line 82. Inverter/converter 60 converts the recovered energy and transfers the energy via electrical line 84 to energy storage device 62 for storage. Hybrid assembly 16 thereby selectively recovers energy from powertrain 12 and/or additional axle 14.

Energy stored in energy storage device 62 is used to power operations system 64 via electrical line 86. Energy stored in energy storage device 62 is transferred to inverter/converter 66 via electrical line 88. Inverter/converter 66 converts the energy and transfers the converted energy via electrical line 90 to drive device 67. Drive device 67 uses the energy to drive one or more mechanical connectors 52, which are operably connected to any combination of portions of powertrain 12 such as power source 18, vehicle axle 22, accessory drive 24, transmission 26, transfer case 28, and/or driveshaft 30. Detachable module 50 is thereby mechanically connected to powertrain 12 and/or additional axle 14 when vehicle 10 is in the low performance or hybrid mode, where hybrid assembly 16 selectively transmits energy and contributes to the drive of powertrain 12 and/or additional axle 14. Detachable module 50 may also drive powertrain 12 when power source 18 is not operating, thereby providing vehicle 10 with “silent watch,” “silent move,” and/or “no idle” features. Additional axle 14 may be rotated by motion of vehicle 10 over the ground, wherein energy may be recovered from at least one of powertrain 12 and additional axle 14.

In step 202, it is determined whether high performance is desired. If high performance is not desired, vehicle 10 continues to operate as described above in step 200. If high performance is desired, detachable module 50 is detached in step 204. Jacking system 74 operates to help provide a quick-disconnect of coupling system 56 to detach detachable module 50 from vehicle 10. Detachable module 50 is detached and removed from vehicle 10. Detachable module 50 may continue to operate independently of vehicle 10, for example, as an independent power source.

In step 206, vehicle 10 operates in the high performance mode. Because detachable module 50 is detached, vehicle 10 operates with a lesser amount of weight, allowing powertrain 12 to drive vehicle 10 at higher speeds and acceleration rates.

In step 208, it is determined whether the high performance mode is still desired. If the high performance mode is still desired, vehicle 10 continues to operate as described in step 206 above. If the high performance mode is no longer desired, detachable module 50 is re-attached to vehicle 10 in step 210. Jacking system 74 operates to help provide a quick-connect of coupling system 56 to attach detachable module 50 to vehicle 10. Vehicle 10 then returns in step 212 to operating in hybrid mode, as described in step 200 above.

The above exemplary disclosed assembly may provide a method for making vehicle 10 quickly adaptable between a high performance mode and a hybrid or low performance mode, allowing vehicle 10 to be versatile in responding to rapidly changing mission requirements. Vehicle 10 may provide benefits in the high performance mode including high speeds, high power output, and high acceleration. Vehicle 10 may provide benefits in the hybrid mode including saving fuel and mitigating noise levels for executing “silent watch” and “silent move” operations. Vehicle 10 may also provide a “no idle” benefit in the hybrid mode, wherein vehicle systems may operate with power from detachable module 50, without power source 18 having to operate.

It will be apparent to those skilled in the art that various modifications and variations can be made to the disclosed apparatus and method. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. An apparatus for a hybrid vehicle comprising:
a detachable module including an energy storage device and a module drive device connected to the energy storage device, the module drive device configured to convert between electrical energy and mechanical energy;
an energy recovery device electrically connected to the energy storage device; and
a mechanical connector selectively connecting the module drive device to a vehicle powertrain, wherein the module drive device drives the powertrain via the mechanical connector.

2. The apparatus of claim 1, wherein the mechanical connector is operably connected to a transfer case of the powertrain.

3. The apparatus of claim 1, wherein the mechanical connector is operably connected to one of a transmission and a driveshaft of the powertrain.

4. The apparatus of claim 1, wherein the mechanical connector is operably connected to an accessory drive of the powertrain.

5. The apparatus of claim 1, wherein the mechanical connector is operably connected to a power source of the powertrain.

6. The apparatus of claim 1, wherein the mechanical connector is operably connected to a vehicle axle of the powertrain.

7. The apparatus of claim 1, wherein the detachable module is rigidly attached to the vehicle, the detachable module further including an additional axle disposed outside of the powertrain.

8. The apparatus of claim 1, wherein the detachable module is rigidly attached to a support frame disposed on a bed of the vehicle.

9. The apparatus of claim 1, wherein the energy recovery device is a flywheel generator configured to recover energy from a power source of the powertrain.

10. The apparatus of claim 1, wherein the energy recovery device is a motor-generator configured to recover energy from an additional axle disposed outside of the powertrain.

11. The apparatus of claim 10, wherein the motor-generator selectively drives the additional axle disposed outside of the powertrain.

12. The apparatus of claim 1, further including a jacking device for attachment and detachment of the detachable module from the vehicle.

13. The apparatus of claim 1, wherein the mechanical connector includes one of a driveshaft, a hydraulic hose, and a pneumatic hose.

14. A method for adapting a high performance vehicle into a hybrid vehicle, the vehicle having a powertrain including a power source, a drivetrain, and a vehicle axle, the method comprising:
selectively attaching a detachable module to the vehicle at a location outside of the powertrain;
selectively recovering energy from the powertrain;
storing the energy in the detachable module;
selectively mechanically connecting the detachable module with the powertrain; and
selectively contributing to driving of the powertrain by using the energy stored in the module.

15. The method of claim 14, including disposing an additional axle integrated into the module, unconnected to the powertrain, and rotated by motion of the vehicle over the ground, wherein the selectively recovering energy includes recovering energy from at least one of the powertrain and the additional axle.

16. The method of claim 14, including selectively contributing to propelling the vehicle over the ground using energy transmitted to the additional axle.

17. The method of claim 14, wherein the selectively recovering energy from the powertrain includes selectively transmitting energy to the detachable module via the mechanical connector.

18. An apparatus for converting a vehicle to a hybrid vehicle, the vehicle including an engine, a powertrain, and one or more axles connected to the powertrain, the apparatus comprising:
a detachable module including a battery and a motor-generator connected to the battery, the motor-generator configured to convert between electrical energy and mechanical energy;
an energy recovery device electrically connected to the battery; and
a mechanical connector selectively connecting the motor-generator to the vehicle powertrain, wherein the motor-generator drives the powertrain via the mechanical connector.

19. The apparatus of claim 18, wherein the energy recovery device is associated with the vehicle powertrain.

20. The apparatus of claim 18, further including an integrated additional axle that is unconnected to the powertrain, wherein the energy recovery device is associated with the additional axle.

21. The apparatus of claim 18, wherein the vehicle has an electrical system and a cooling system, and wherein the detachable module further includes a controller configured to be electrically connected to the vehicle electrical system and a cooling system configured to be fluidly connected with the vehicle cooling system.
